(19) United States
(12) Patent Application Publication
(10) Pub. No.: US 2016/0225016 A1
(43) Pub. Date: Aug. 4, 2016

(54) Advertisement-Based Gaming System And Method

(71) Applicants: Amrish Patel, Watertown, MA (US); Sneha Patel, Watertown, MA (US)

(72) Inventors: Amrish Patel, Watertown, MA (US); Sneha Patel, Watertown, MA (US)

(21) Appl. No.: 15/012,251

(22) Filed: Feb. 1, 2016

Related U.S. Application Data
(60) Provisional application No. 62/110,126, filed on Jan. 30, 2015.

(51) Int. Cl. G06Q 30/02

(52) U.S. Cl. CPC G06Q 30/0245; G06Q 30/0259

(57) ABSTRACT

An advertising-based gamification system delivering advertisements and measuring delivery and attention to the advertisements, including an allocation server, a database including stored data objects including media advertisements and questions in a plurality of languages, each of the questions associated with a particular media advertisement, a translation module monitoring translation statuses of each of the stored data objects in the plurality of languages, a location module receiving location data indicative of a location of at least one of the plurality of devices, software selectively presenting one of the media advertisements and a plurality of associated questions from the stored data objects to a device based on at least one of the location data and a language preference, software to receive and store data indicative of answers to the questions from the device, and software executing on the allocation server to quantify views and attention of the media advertisements.

### FIELD OF THE INVENTION

The present invention relates to the field of electronic content delivery and specifically to an advertisement-based gaming system and method, including hardware, software, and logistics therefor.

### BACKGROUND OF THE INVENTION

Advertisers constantly seek new and improved ways of reaching potential consumers and retaining existing customers. Today, changes in technology have opened the door for novel ways of presenting and disseminating advertisements, potentially decreasing the effect of advertisements conveyed through traditional media.

For instance, in some markets, the maximum number of minutes of advertising on television per hour of programming or the number of advertising breaks per program are capped. Alternatively, some markets limit the availability of part-screen or drop-down advertisements on television. Print newspapers and periodicals are losing readers to the web. Advertisers are therefore required to seek other means of disseminating their advertisements. While the Internet has provided new means of relaying advertisements for years, accessing and using the Internet from mobile devices is becoming increasingly popular and has, in some markets, surpassed desktop Internet usage. As mobile Internet becomes more popular, new methods of distributing advertisements to mobile devices are required.

With online and mobile advertisements, it is difficult to identify how many individuals actually view and comprehend the advertisement content. It is also becoming more common for desktop and mobile users to employ ad-blocking software and/or to skip over ads rendering Internet-based ads less effective.

Additionally, there is a need for a method of distributing advertisements that consumers not only want to view, but to which they wish to provide their undivided attention. There is also a need to measure the number of actual views and the effectiveness of such advertisements immediately following the viewing of the advertisement.

Further, there is a need for a simple and secure way to distribute prizes, including prize money, to game players, and to be able to track where they use and spend their prizes. In part, the need to track comes from the desire to determine whether the advertisements shown to the player were successful in their aims.

### SUMMARY OF THE INVENTION

It is an objective to provide a means to increase the probably that electronic content, such as an advertisement, is viewed in its entirety and given full attention by a recipient. The system and method provides direct feedback or proof that advertisements are watched in data from questions being answered. It is also an objective to ensure that users are delivered content that is particularly relevant to them, based on location and/or topics of interest.

It is a further object to increase the effectiveness of advertisements in getting users to online or physical purchase locations. It is an objective of the invention to measure the delivery and effectiveness of the advertisements not only directly after the time of viewing the advertisement, but also when the player (now a consumer) makes a purchasing choice in a relevant market.

It is a further objective of the invention to provide an advertising system in the form of a game in which advertisements are used to allow players to win prizes, including money. It is a further objective of the invention to make players want to play the game and desire to continue playing, and, in turn, pay attention to the advertisements, by incorporating elements of games of skill and chance into the game. It is a further objective of the invention to provide a game in which a user is challenged by a game of skill and rewarded with a game of chance.

It is a further objective of the invention to study the transformation of player response and consumer purchases to marketing and advertising data.

It is a further objective of the present invention to educate consumers regarding available brands and products and provide brand messaging and awareness solutions.

It is a further objective of the invention to provide a game which increases player's cognitive abilities.

Accordingly, a system and method for an advertisement-based game is proposed herein. In one exemplary embodiment, the system includes an allocation server in communication with a plurality of player devices programmed to present media advertisements and receive user input in response to questions posed about the media advertisements. The allocation server presents the media advertisements to a plurality of users via the player devices, presents questions via the player devices based on the media advertisements, and receives data indicative of answers to the questions. In some embodiments, the allocation server determines awards for each of the users based at least in part on the answers and notifies the users and/or a payment server. The users may be issued a payment card with the award amount for use at any retailers, or a previously issued payment card is updated. In some embodiments, purchase data is determined from the use of the payment card and transmitted to media distributors or advertisers associated with the media advertisements.

Further provided is an advertising-based gamification system for delivering advertisements and measuring delivery and effectiveness of the advertisements. The system includes an allocation server, in communication with a plurality of devices remote to the allocation server, programmed to present media advertisements for display on the plurality of devices and receive user input in response to questions posed about the media advertisements from the plurality of devices. The system also includes a database including a plurality of stored data objects including media advertisements and questions, each of the questions associated in the database with a particular media advertisement, the media advertisements and the questions stored in a plurality of languages. A location module executes on the allocation server to receive location data indicative of a location of at least one of the plurality of devices. Software executing on the allocation server selectively presents one of the media advertisements and a plurality of associated questions from the stored data objects for transmission to and display on a device based on at least one of the location data and a language preference. Software executing on the allocation server receives and stores data indicative of answers to the questions from the device. Further, software executing on the allocation server to quantifies views and effectiveness of the media advertisements.

In some embodiments, the system includes a translation module executing on the allocation server that monitors translation statuses of each of the stored data objects in the plurality of languages in the database. The translation module may issue commands to deactivate data objects including media advertisements and questions having incomplete or out of date translations. The translation module may also transmits alerts to one or more administrators in response to a detection of an incomplete or out of date translation of one of the media advertisements or the questions.

In some embodiments, at least a portion of the plurality of devices are mobile devices including GPS devices sending the location data to the allocation server. At least a portion of the media advertisements and associated questions presented for display on the device are associated with products or services offered in a current location of the device based on the location data. The location data may also include network data indicative of a wireless network in use by a device, wherein at least a portion of the media advertisements and associated questions presented for display on the device are associated with products or services offered in a current location of the device based on the network data.

Also provided is a method of providing an advertising-based gamification system for delivering advertisements and measuring delivery and effectiveness of the advertisements, including the steps of storing, via software executing on an allocation server, a plurality of data objects in a database, the data objects including media advertisements and questions stored in a plurality of languages and monitoring, via software executing on the allocation server, the data objects to determine if each data object is stored in each of the plurality of languages. The method includes activating, via software executing on the allocation server, data objects in which a media advertisement and a predetermined number of questions associated with the media advertisement are available in each of the plurality of languages. The media advertisement and two or more of the questions associated with the media advertisement are selectively presented for display on a device based on at least one of a location and a language of a user of the device. Data indicative of answers to the two or more of the questions is received from the device.

Other objects of the invention and its particular features and advantages will become more apparent from consideration of the following description and accompanying drawings.

### BRIEF DESCRIPTION OF THE DRAWINGS

FIG. 1 illustrates an exemplary embodiment of a system according to the present invention.

FIG. 2 illustrates an exemplary embodiment of a method according to the present invention.

FIG. 3 illustrates an exemplary embodiment of a system according to the present invention.

FIG. 4 illustrates an allocation server and database of the system shown in FIGS. 1 and 3.

FIGS. 5A-5D illustrate exemplary interfaces of a system and method according to the present invention.

FIGS. 6A-6B illustrate exemplary interfaces of a system and method according to the present invention.

FIGS. 7A-7J illustrate exemplary registration and settings interfaces of a system and method according to the present invention.

FIGS. 8-9 illustrate exemplary help and sharing interfaces of a system and method according to the present invention.

FIGS. 10A-10B illustrate exemplary account interfaces of a system and method according to the present invention.

FIGS. 11A-11D illustrate exemplary game play interfaces of a system and method according to the present invention.

FIG. 12 illustrates an exemplary game play interface of a system and method according to the present invention.

FIGS. 13A-13C illustrate exemplary game summary interfaces of a system and method according to the present invention.

FIGS. 14A-14M illustrate exemplary achievement interfaces of a system and method according to the present invention.

FIGS. 15A-15D illustrate exemplary leaderboard interfaces of a system and method according to the present invention.

### DETAILED DESCRIPTION OF THE INVENTION

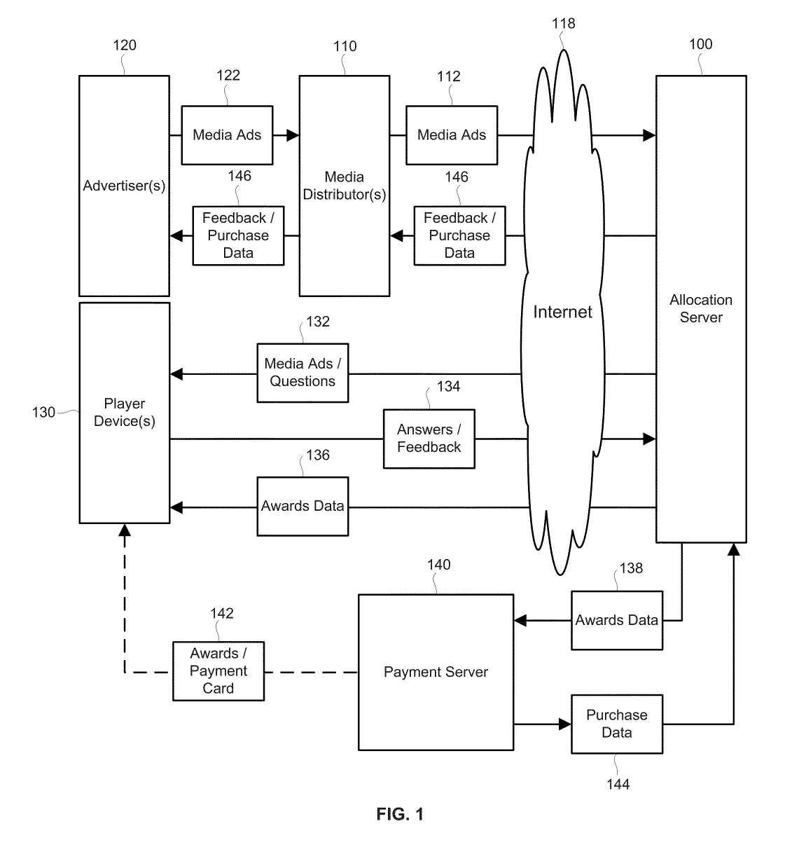

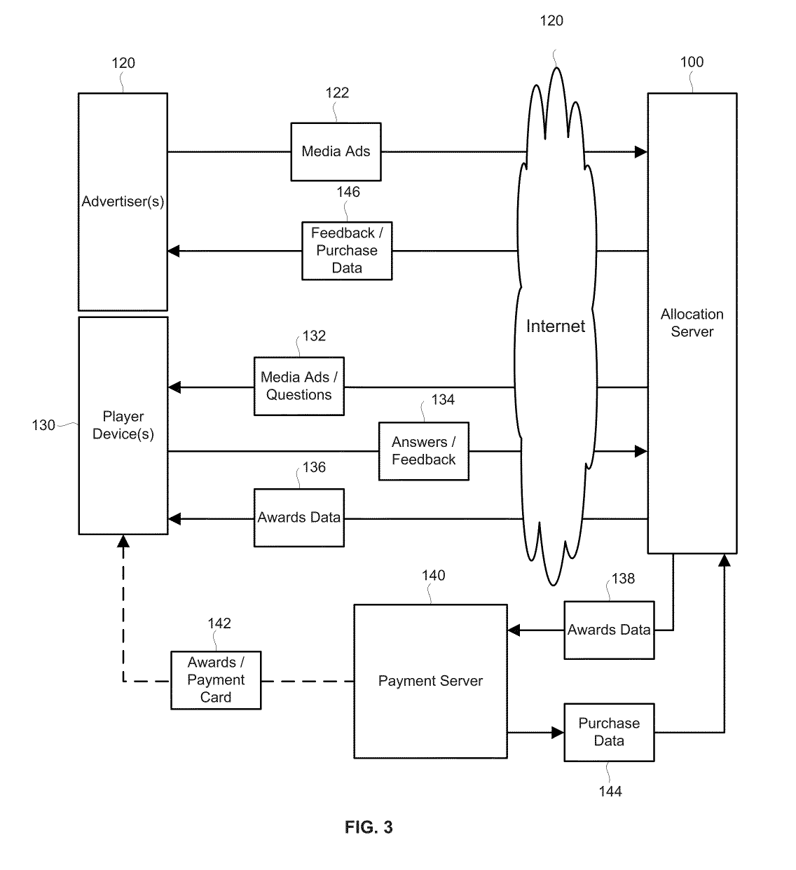

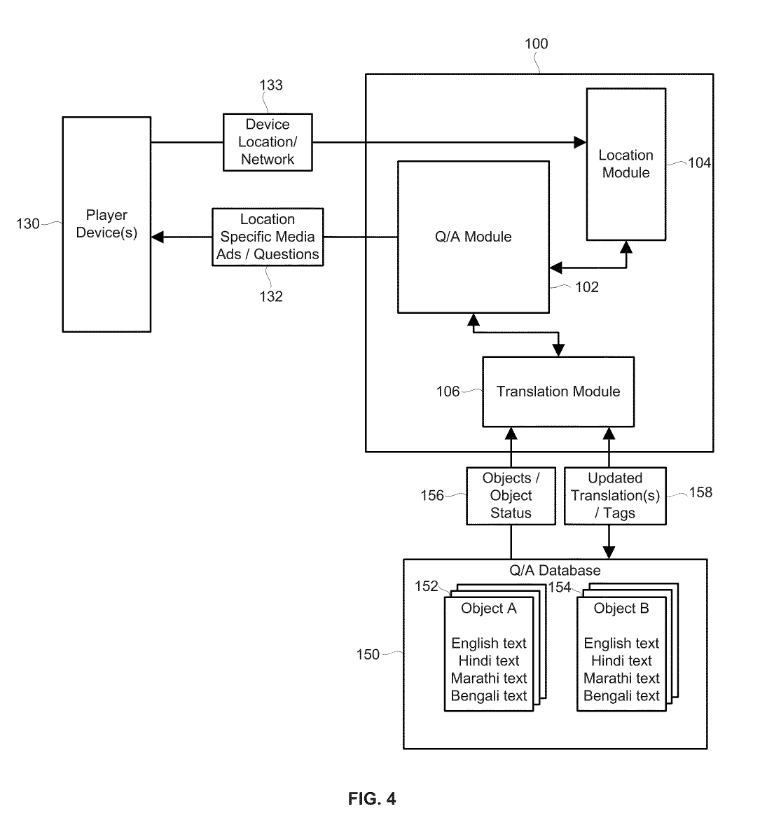

FIGS. 1-4 illustrate exemplary embodiments of the system and method according to the present invention. As shown in FIGS. 1 and 3, the system includes an allocation server 100 (embodied in hardware) which provides a portal for media buyers and advertisers 110/120 to directly reach end users via various devices 130 (e.g., mobile devices, computers, specialized kiosks). The allocation server 100 is programmed to present media advertisements and questions 132 to the devices 130, via the Internet 118, and receive user input 134 in response to the questions posed about the media advertisements. In particular, the allocation server 100 may include a processor and a number of software modules executing thereon to carry out the functions described herein. As shown in FIG. 4, the allocation server 100 may include a question and answer or communication module 102, a location module 104, and/or a translation module 106. The allocation module 100 also includes or is in communication one or more databases, such as the database 150.

As shown in FIG. 1, to gather the necessary resources for the game, advertisements 112 (e.g., video advertisements) are received from media distributors 110 (e.g., via the Internet) (step 201). Alternatively, advertising agencies, advertisers, manufacturers, retailers, corporations, institutions, or others seeking to promote a product, service, brand, trade, trademark, service mark, or the like 120 may provide the advertisements 122 directly (see FIG. 3). For example, in some embodiments, the allocation server 100 may incorporate a media distribution server or functions thereof. Advertisements 112 are preferably video, but may also be still image, audio, rich content, any combination thereof, or any other type of multimedia.

Advertisement sources 110/120 may pay for their advertisements to be included in the system. In one embodiment, there is a fixed price per ad impression-click-response. Alternatively, prices for inclusion may be negotiated. In some embodiments, algorithms determine the best prices paid for each ad impression-click-response. A portion of the revenue received from the advertising sources 110/120 is distributed to the users in the form of awards 136/138 representing a monetary value that may be redeemed by the users. The monetary awards provide an incentive for users to play and, in turn, view and comprehend more advertisements.

Advertisements 122 may be designated for use in specific demographics, including gender, age, ethnicity, knowledge of languages, disabilities, mobility, home ownership, employment status, parental status, etc. Additionally, certain advertisements 122 may be designated for use in specific locations, including, but not limited to, localities, regions, countries, or world-wide, or any subset thereof, depending on the needs of the advertisement source. Such designations allow advertisers 110/120 to reach their target demographic and spend their advertising money more efficiently. Advertisers 110/120 may also designate that advertisements for use in non-user-specific manners, such as the advertisement could be viewed at certain times of day.

In order to deliver targeted advertisements, the system may select advertisements 132 for a particular user based on location information (e.g., zip code or city) shared by the user during a sign up procedure. Alternatively, or in combination, the system may employ real-time location information received and analyzed by a location module 104 executing on the allocation server 100 as shown in FIG. 4. In some embodiments, the system receives global positioning system (“GPS”) location information 133 shared by GPS devices in the users' computers or mobile devices 130. In other embodiments, the system receives network information 133 shared by the users' computers or mobile devices 130. For example, the devices 130 may share the identity of the wireless network currently being used. Thus, if the user is, for example, on a Wi-Fi network in a particular coffee shop (or on public Wi-Fi in the vicinity), the identity of this network is shared with the system in real-time and allows for delivery of targeted advertisements based on the particular location. The user might then receive a video advertisement for the particular coffee shop and receive an award of coupons or free products or services for game play while in that particular location. The system may also present advertisements associated with businesses in the vicinity of the precise location of the device (e.g., same neighborhood, street, etc.).

In some embodiments, the system may further present advertisements and questions to a user based on their location together with their real time use of coupons and/or purchases (e.g., using a debit card associated with the system) at the location. For example, if the user purchases dinner at one location, the system may present advertisements for dessert establishments nearby or transportation services to get home. Each of the advertisements and/or questions in the database 150 may be tagged with location information that is compared to and matched with location data 133 associated with the user and/or device by the location module 104.

As shown in FIGS. 1-3, media advertisements 112 received from a media distributor 110 (e.g., who may receive media advertisements 122 from a plurality of advertisers 120) are transmitted to the allocation server 100 (e.g., via the Internet 118), stored in the database 150, and translated as necessary. The media advertisement data 112 may include associated questions provided by the advertiser, or the questions may be generated by the allocation server 100 or an administrator thereof.

The questions are stored in databases in communication with the allocation server (e.g., database 150) and associated with certain advertisements. Questions 132 can be directed to an assortment of advertisement and marketing themes, and can include, but are not limited to questions about the advertisement played, questions about the brand, product, or company advertised. Questions 132 may be directed toward specific details in the advertisements to test a player's memory and cognitive skills and improve them over time. In an embodiment of the invention, advertisement sources 110/120 may generally indicate the type of questions they are seeking to ask. Questions 132 may be multiple choice, in which one or more answer choices may be selected, free response, or a combination thereof. In an embodiment of the invention, questions 132 are multiple choice with one correct answer.

The media ads and questions 132 are then presented to any number of player devices 130 via the Internet (step 203). Player devices 130 are specialized kiosks, computers, or mobile devices. In some embodiments, the media ads 132 are presented via a mobile application executing on a smart phone, tablet, or other smart device, or in an Internet browser on a mobile device or computer. Player devices may include computers running any operating system environment (Windows, Mac OS X, Linux, UNIX, BSD, etc.), any web browser (Safari, Chrome, Opera, Firefox, Internet Explorer, etc.), and any software specifically designed to be a player device. Applications for mobile devices may be developed and provided for platforms such as Android, iOS, Windows Phone, Blackberry, Tizen, and other mobile platforms. In one embodiment of the invention, specialized kiosks are specifically designed to run the game and provide additional game-related services, as described herein.

In one embodiment, the game is embeddable into websites, such as those of the advertising company 120 themselves or other third-parties. Those who embed the website may do so in order to provide a continuous customer experience and reinforce a brand's message. Those who embed the game onto their website may be provided a commission based on the number of plays the embedded game receives, the amount of time players play on the website, a fixed fee, or another method of calculating an appropriate commission. In an embodiment of the invention, those who embed the game on their website may be provided with a referral commission akin to those who refer other players as described herein, in which they are paid a percentage of the referred players' winnings while they play on the embedded game.

The allocation server 100 receives data 134 back from the devices, e.g., in response to the media ads and questions 132. The data 134 includes answers to questions, but may also include, inter alia, the amount of time it took to answer, a number of correct/incorrect answers, and/or comments or ratings from the user of the device 130.

In a preferred embodiment, the advertisements and/or questions 132 are translated into a number of different languages (e.g., by a translation module 106 shown in FIG. 4) so as to increase the target audience. In an embodiment, the number of languages is established by the languages used in the location to which the advertisement will be targeted. By way of example, some embodiments of the system may be compatible with English, Hindi, Bengali, Urdu, Gujarati, Marathi, Telugu, Tamil, Kannada, Malayalam, and many other languages. In an embodiment, the number of languages is ten. In another embodiment, the number of languages is forty. Support for languages in allocation server 100 and player devices 130 may be added as necessary, and may include languages which utilize non-western characters, alphabets and writing systems (including those read right-to-left), including but not limited to, Arabic, Mandarin, Cyrillic, Cantonese, Greek, Japanese, and Urdu.

Translation may be done manually, using a computer or algorithm for machine translation, or using a computer or algorithm for machine translation followed by a manual check for translation accuracy. The exemplary embodiment includes a management console module (e.g., software) executing on the allocation server 100 which allows administrators to log-in and set up a new language on the fly. Words and terms associated with the game are first machine translated into a new language chosen by the administrator and the translations are checked and/or modified by the administrator. Upon acceptance, the new language becomes available for use on any player devices 130.

The system according the present invention includes the translation module 104 and/or software on the allocation server 100 to monitor and update translations in real time. As new advertisements and questions are added the system's database 150, the translation module 106 issues alerts to translate such new advertisements and questions into some or all of the available languages. The system provides full UTF8 and Unicode compliance.

The translation module 106 continuously checks translation statuses in the database 150 and identifies out of sync or out of date translations and notifies appropriate translators. As shown in FIG. 4, the database 150 includes an object/model classification system to allow translation of database and code objects (and properties). Advertisements and questions are stored as objects 152/154 in the databases 150. Objects 154 can be any logical unit within a software system. This could include, but is not limited to, Web Pages, Web Objects, Countries, Colors, Sentences, Phrases, Words, Objects, Lists, or Game Components. An object may include each of a plurality of translations in a single object, or each translation is a separate object grouped or related to one another.

When any object or portion thereof is modified, the translation module 106 detects changes and issues alerts to translate remaining portions or related objects into some or all of the available languages. The alerts may be messages to an administrator or individual translators, pop-up messages or warnings on an administrator portal for the allocation server, instructions to the Q/A module 102, or creation of object tags (and/or modification of an object property) saved in the database 150.

The translation module 106 monitors the status of the objects and may automatically make advertisements or questions unavailable/offline in certain languages until translations are complete or checked. For example, if the English version of a question is modified, the corresponding questions in different languages will not be used until the system confirms that they have been translated. This may be performed by a message or alert to the Q/A module 102 and/or by tagging the particular objects in the database 150. When advertisements are being selected to present to a particular user in a particular language, the system also checks to confirm that there are a minimum number of questions (e.g., 6) in the particular language for each advertisement that is in que to present to the user. If the minimum number is not met, the advertisement and associated questions are not used.

To help simplify the translation process, each translation can also carry descriptive “category” information that aids translators or reviewers in identifying and/or grouping translations. Example categories could be color, animal, action, food, etc. In this way words like “shake”, would translated differently if it were food or action. Categorization also allows words and phrases to be grouped for lists or simply for better translations. An example of this might be “Colors”.

The translation module manages custom cascading style sheets (CSS) and fonts for each language. It provides full support for Right to Left (RTL) languages such as Urdu or Arabic and languages that use Latin and non-Latin alphabets. It also allows developers to work in a single language. All objects within the system are translatable and can have multiple translatable properties. A caching system is provided for high performance/high volume translations. The translation module also supports generic translations, for common phrases or general use (e.g., ok, cancel). Translatable objects can be partial and/or full pages.

In some embodiments, translations can require approval from a secondary translator to ensure accuracy. The translation module 106 stores all translatables in the database 150 and uses in-memory caching to provide high-speed translations services. The translation module 106 allows developers to make objects translatable by using class inheritance from the “translatable” class. This registers the class with the translations system and sets up configurations for the translation objects. From this point forward, translations are tracked by Object ID, Object Class, and Object Property. Each object's translation status is tracked; who provided the translation, when the object was translated, and what language the object was translated to.

The translation module 106 also provides for third language comparison. This aids translators in confirming the translations are accurate. For example a translator may check English against Hindi, while another translator would compare the Hindi against Urdu, and finally the Urdu could be compared against the English to confirm that the meaning was not lost.

The translation module 106 can recognize web page components, and keep track of translations based on HTML id fields and page paths. This allows for nearly completely automated management of web page translations. Where programmers can be virtually unaware of translation requirements.

The translation module 106 also supports “Injections”, where data can be injected into the translations. This is useful for sentences that convey dynamic information. For example, “Your account balance is $5.00”. The translation module allows changes in sentence structure while allowing the flexibility to do injections. Another example “Hello, {FirstName}! Welcome to SurplePlay!”

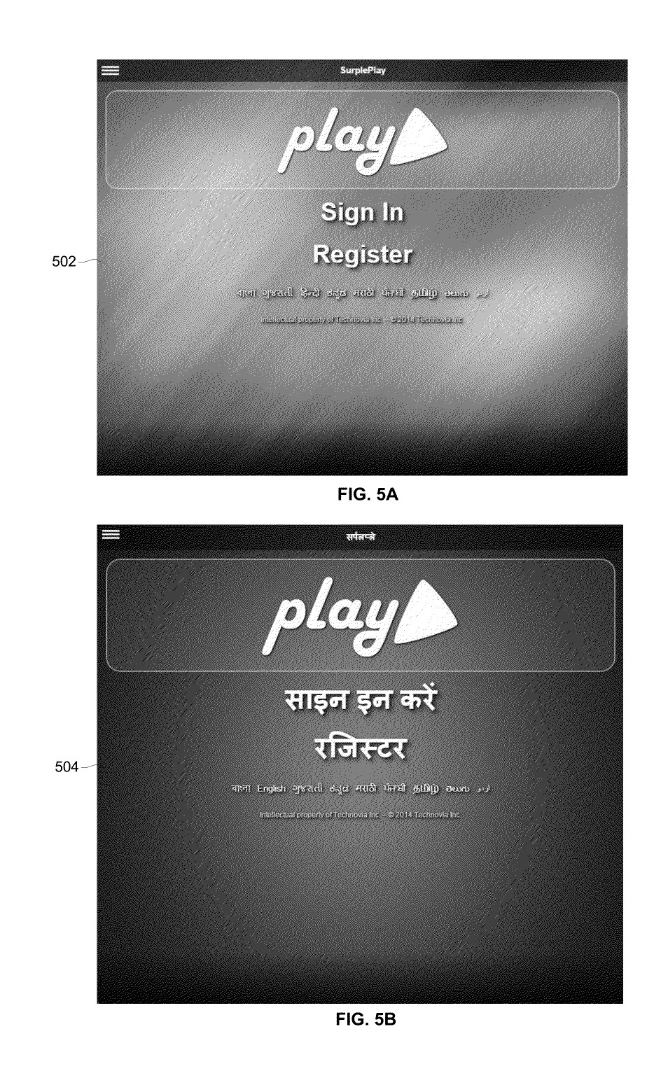

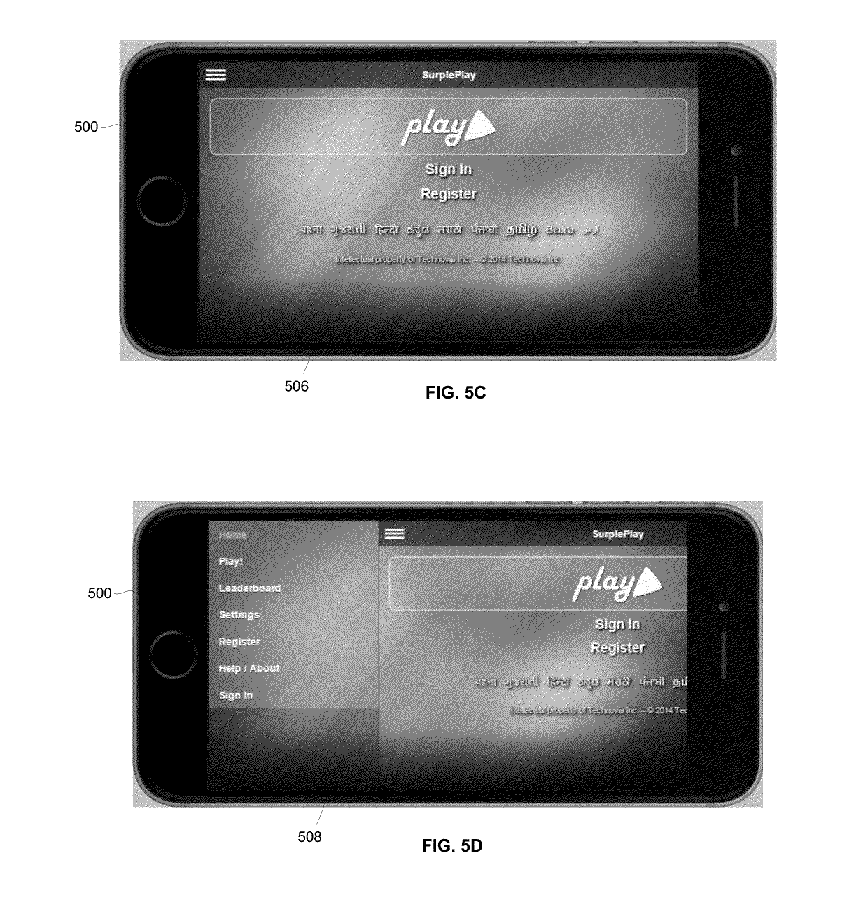

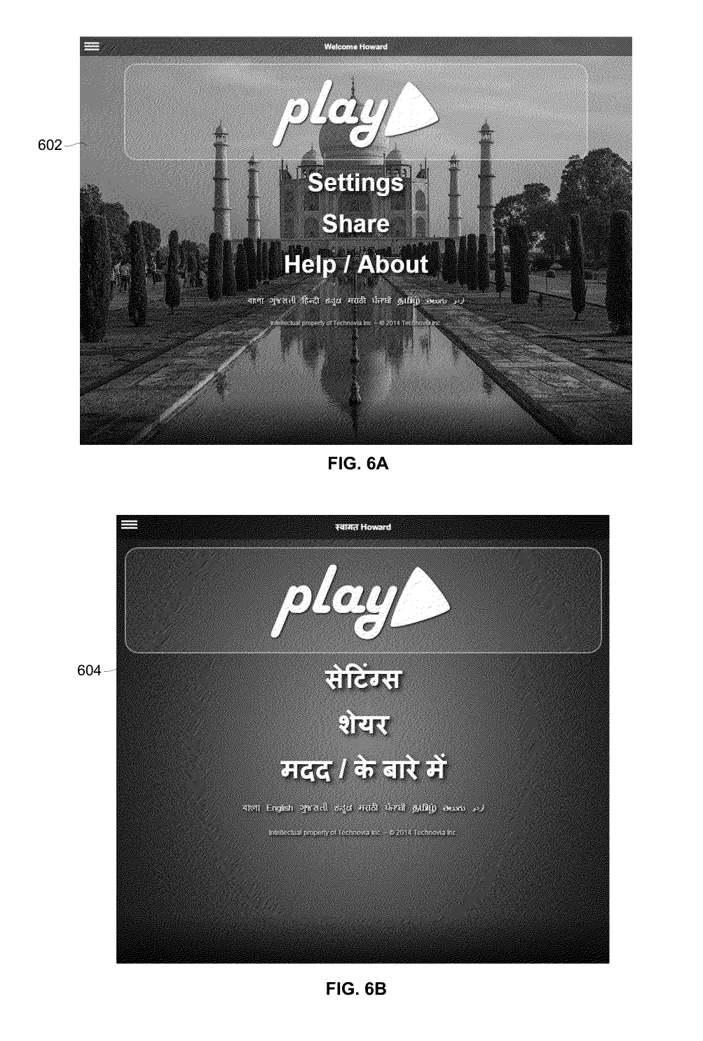

FIGS. 5A-5D show main introduction screens presented to users of the system. As discussed above, the system may present the screens in an interface on a computer, mobile device, or kiosk. FIGS. 5C and 5D illustrate a mobile device 500 programmed according the present invention. FIGS. 6A-6B show secondary screens presented when a user is logged in.

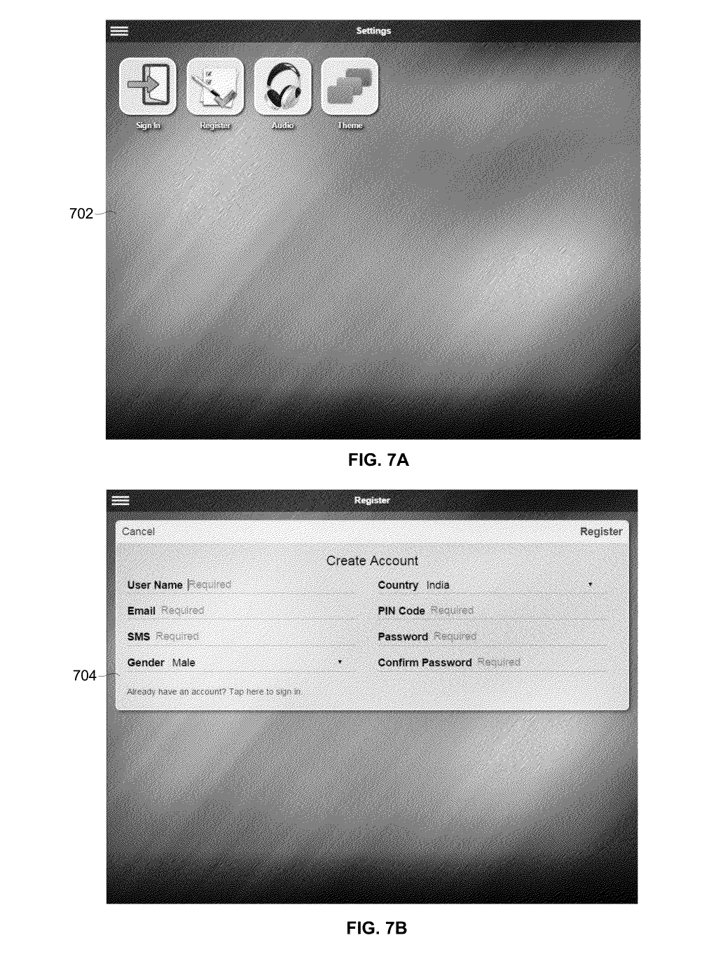

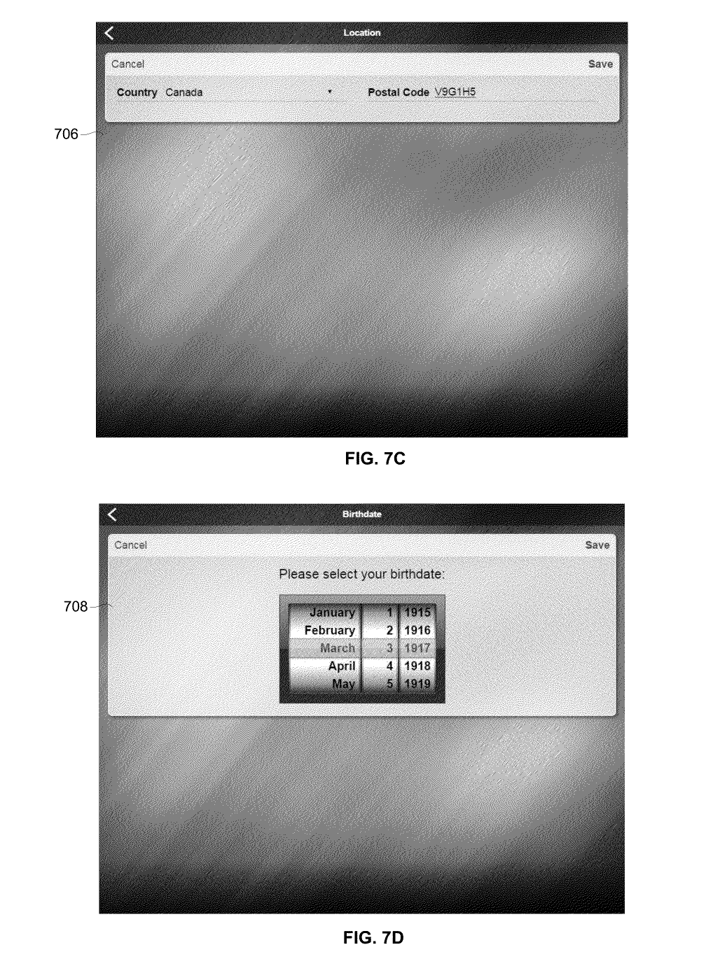

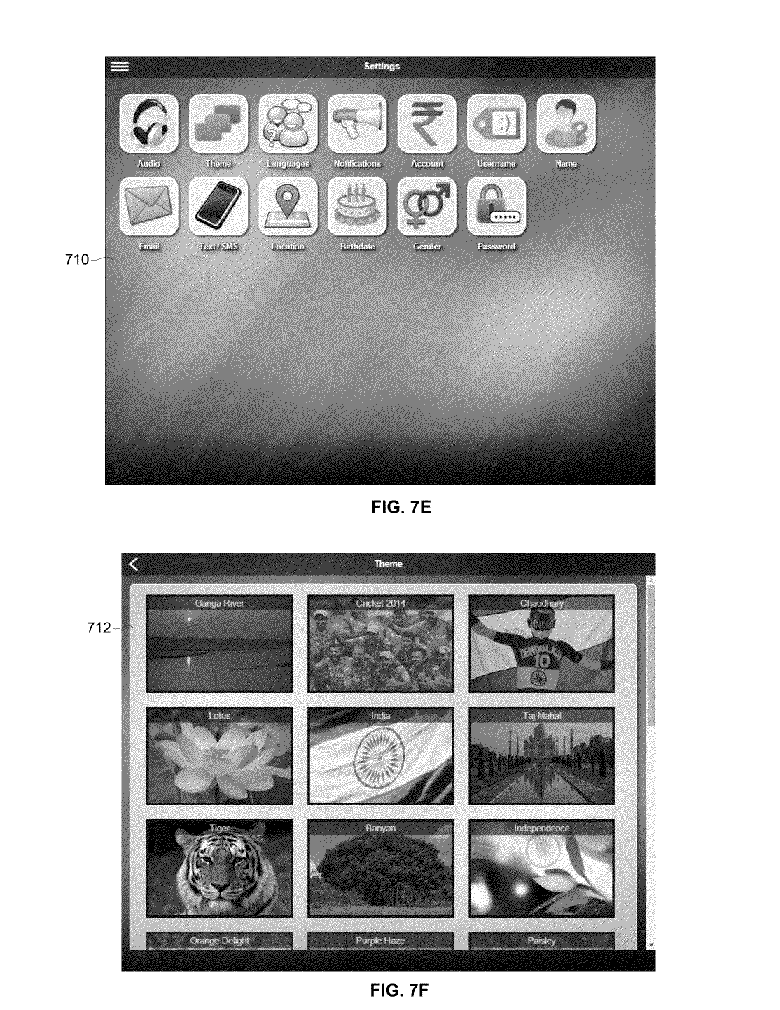

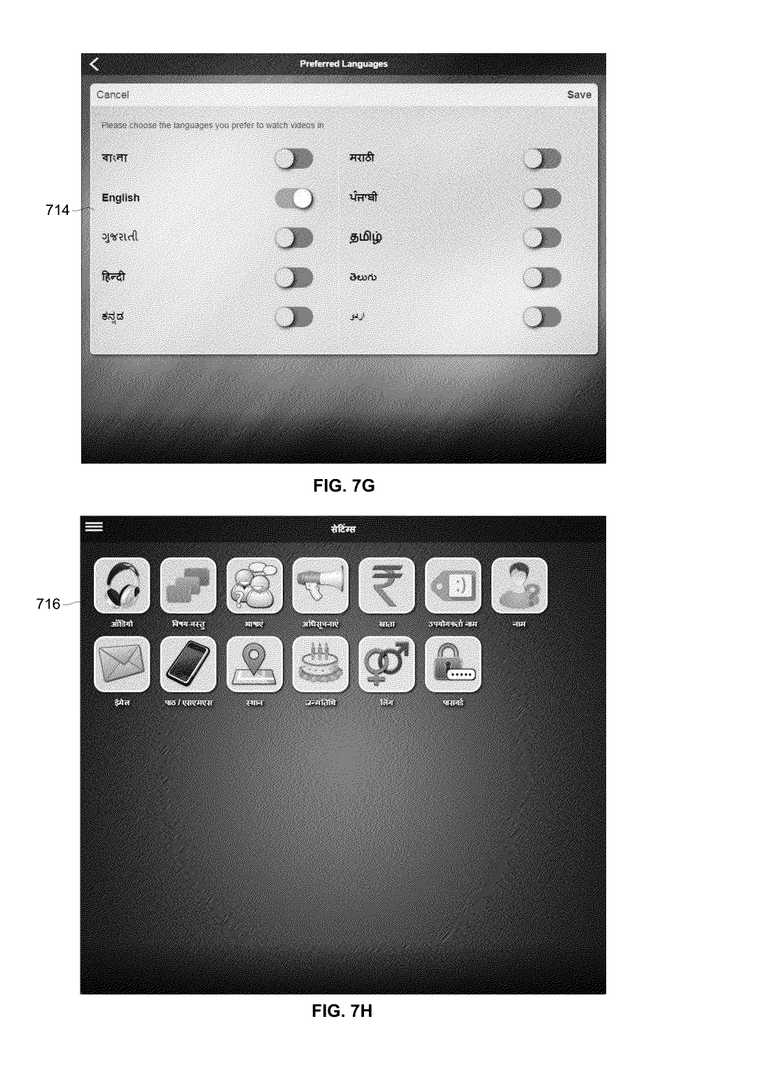

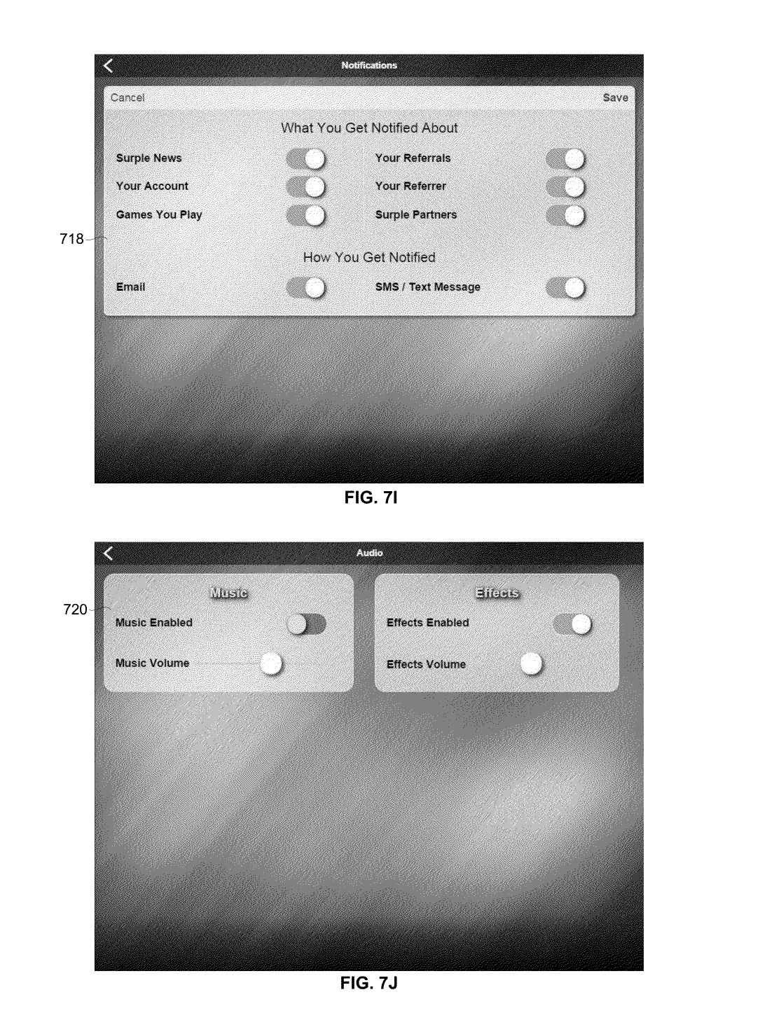

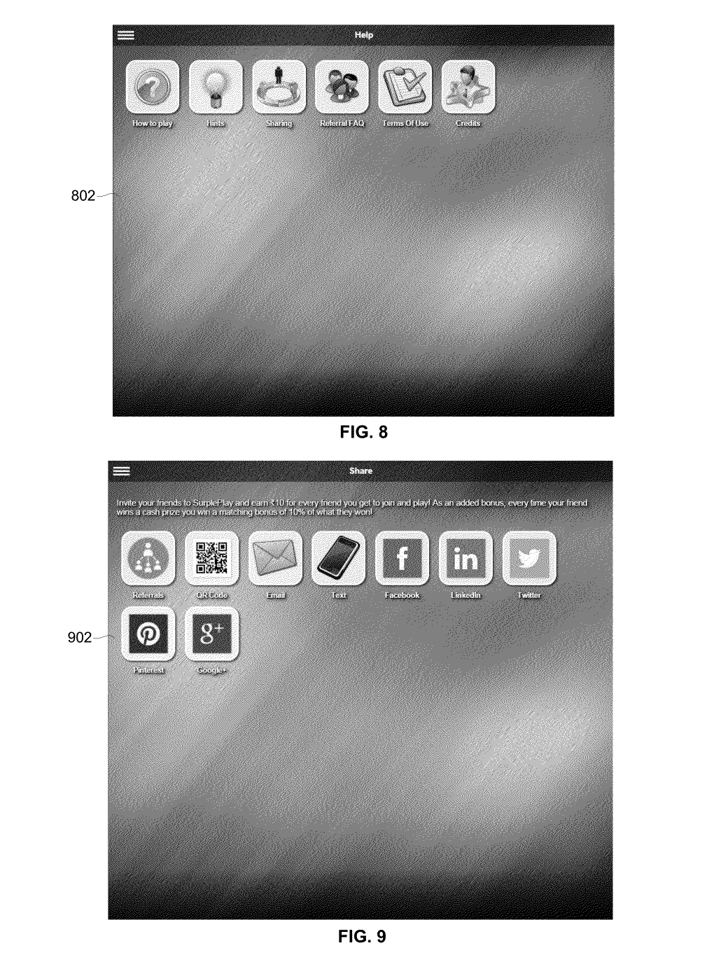

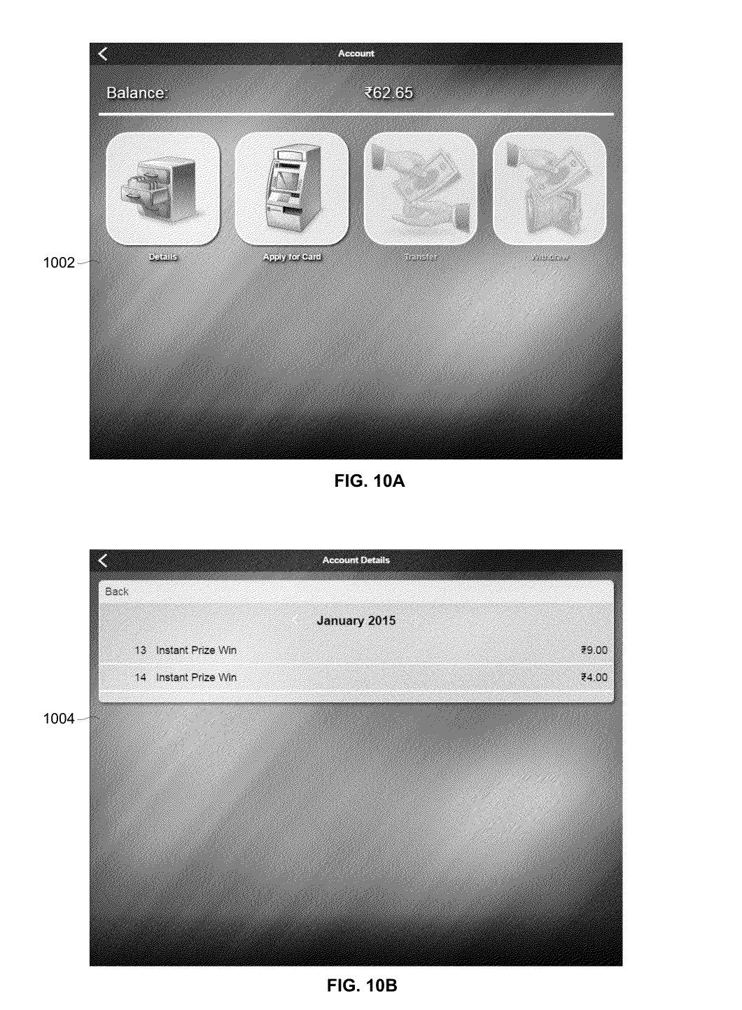

In some embodiments, players must sign up for a player account prior to or while playing the game. FIGS. 7A-7J show a plurality of registration and settings screens of the system. The player is asked for information such as their name, address, gender, age, ethnicity, knowledge of languages, disabilities, mobility, home ownership, employment status, parental status, and/or other demographic information. This allows for tailored experience for the player, and allows advertisers 110/120 to select who views their advertisements 112/122 based on demographic data. As shown in FIGS. 7A-7J, there are also various settings associated with the account that may be set, including audio settings 720, theme settings 712, languages 714, notifications 718, money accounts, usernames, names, email addresses, phone numbers, locations, birthdays, gender, and passwords. Registered users are also presented with various help tools 802 as shown in FIG. 8. FIGS. 10A-10B illustrate Account pages associated with the user.

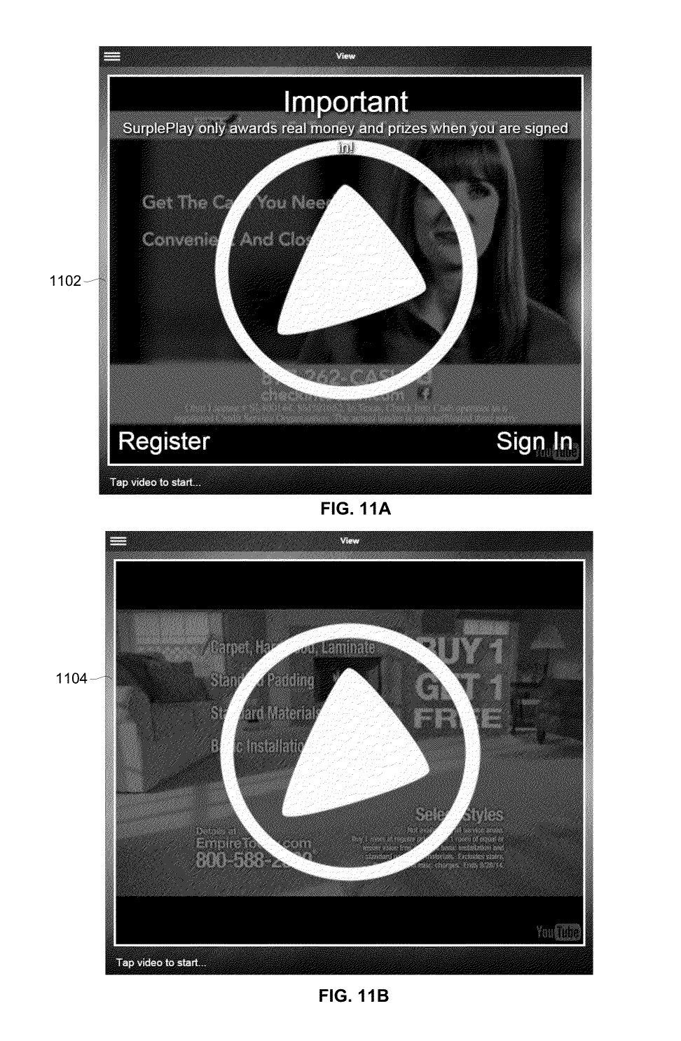

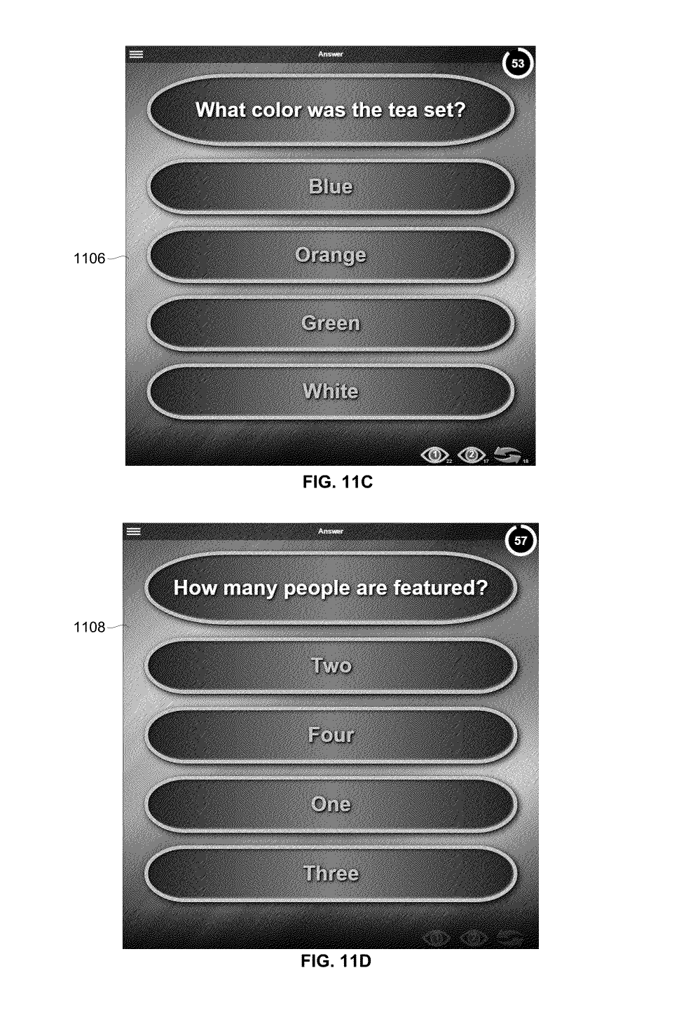

When a player wishes to play the game, they must first set the language(s) in which they want to play (see FIG. 7G). An advertisement 132 is then selected by the allocation server 100 from the set of advertisements available in the language(s) of the player, and potentially meeting the location and/or demographic needs of the advertiser, and sent to the player device 130 via the Internet, along with associated questions 132. FIGS. 11A-14M show screen shots of a video being played, questions answered, prizes being determined, and summary screens of the player's progress.

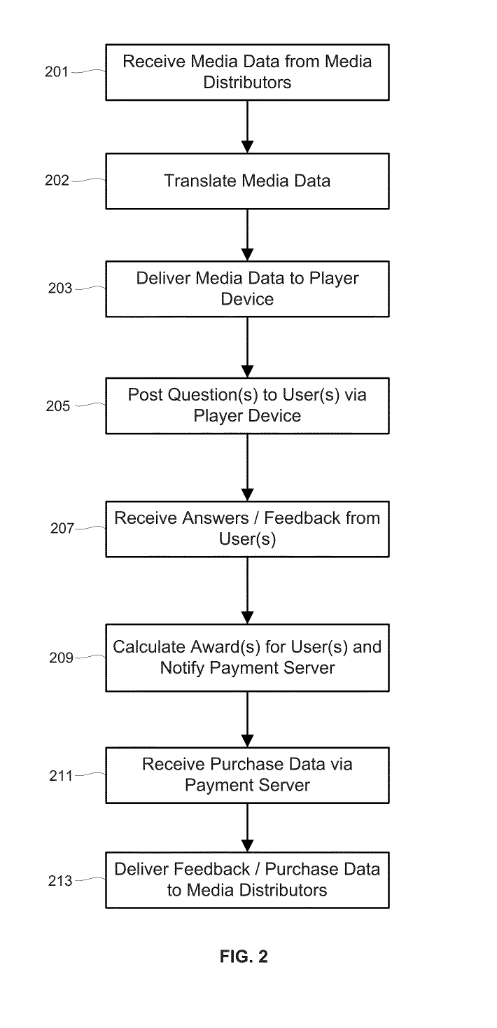

As shown in FIGS. 11A-11B, the player watches, listens to, or otherwise senses the advertisement 122 on player device 130, which is configured with software to display the advertisement. Upon completion of the advertisement 122, a previously-generated question 132 (or series of questions) is presented to the player regarding the advertisement 132 on the player device 130 (FIGS. 11C-11D; FIG. 2, step 205). A plurality of questions exist for any given advertisement and a subset thereof (e.g., 3) may be selected by the allocation server 100 for presentation by player device 130 to the viewer at random. The player then answers the question 132 using the player device 130. In an embodiment, the player's answer 134 is then transmitted from the player device 130 to the allocation server 100 via the Internet 118 (FIG. 2, step 207). The process of asking questions 132 and receiving an answer 134 is iterated until the number of questions to ask the player is reached. In a preferred embodiment, number of questions is three.

In some embodiments, two or more players may play against one another (e.g., remotely on separate player devices 130). Players may compete against each other either head-to-head, on teams, or in tournament play. The same advertisement and set of questions is presented to each player and prizes may be awarded based on who achieves the most correct answers or who does so in the quickest amount of time. Players may compete by trying to answer the most questions correctly, the most consecutive questions correctly, attempting to achieve the highest score, win the most or highest-valued prizes, or by trying to achieve any of the above in the fastest time. In some embodiments, head-to-head games result in non-monetary prizes being awarded to the players. For example, players may compete for a monetary prize that is given to their preferred charity, or split among several charities.

In an embodiment of the invention, where the questions 132 are multiple choice with one correct answer, answering the question correctly rewards the player with a prize or preferably with a chance to win a prize (as described further below). Each correctly answered question is like putting a coin in a slot machine, giving the player a chance to win cash. Alternatively, correct answers may be rewarded with a multiplier which enlarges a potential prize. In embodiments of the invention, prizes or chances to win prizes are awarded after every correct question answered or preferably after every group of questions answered.

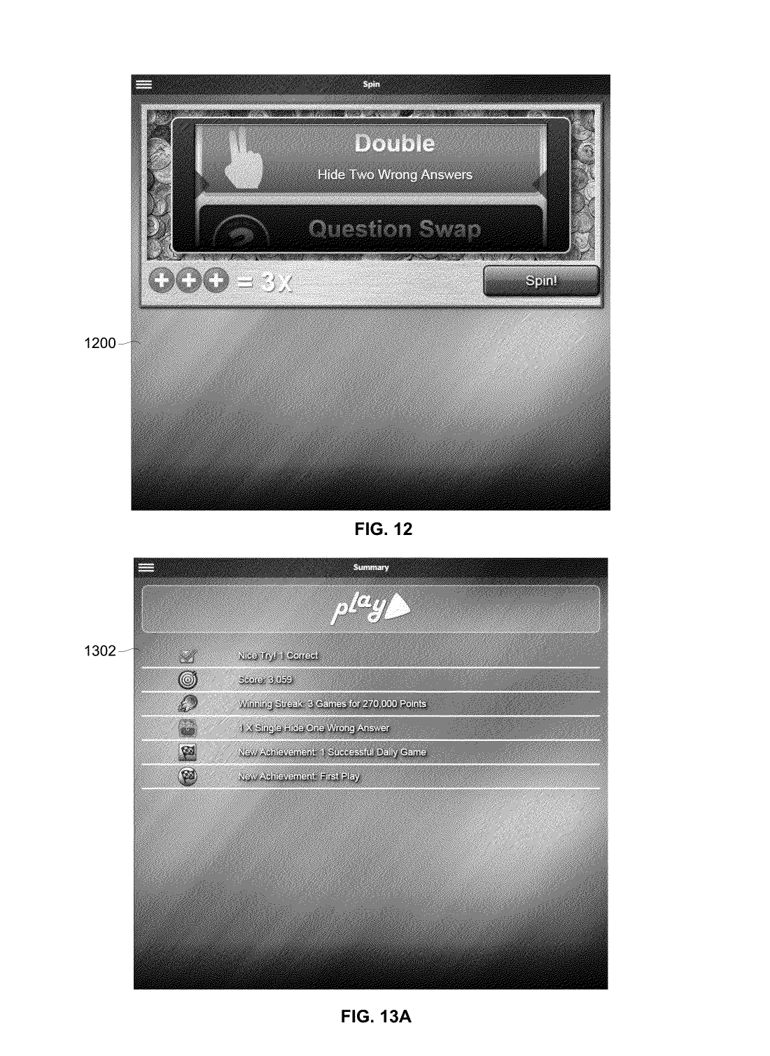

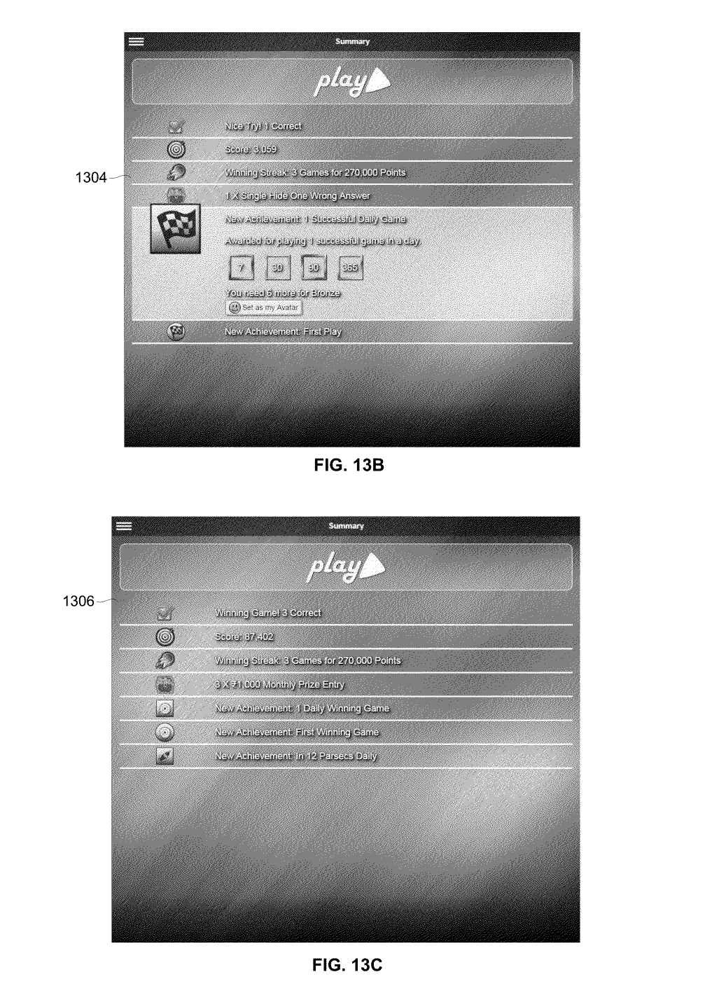

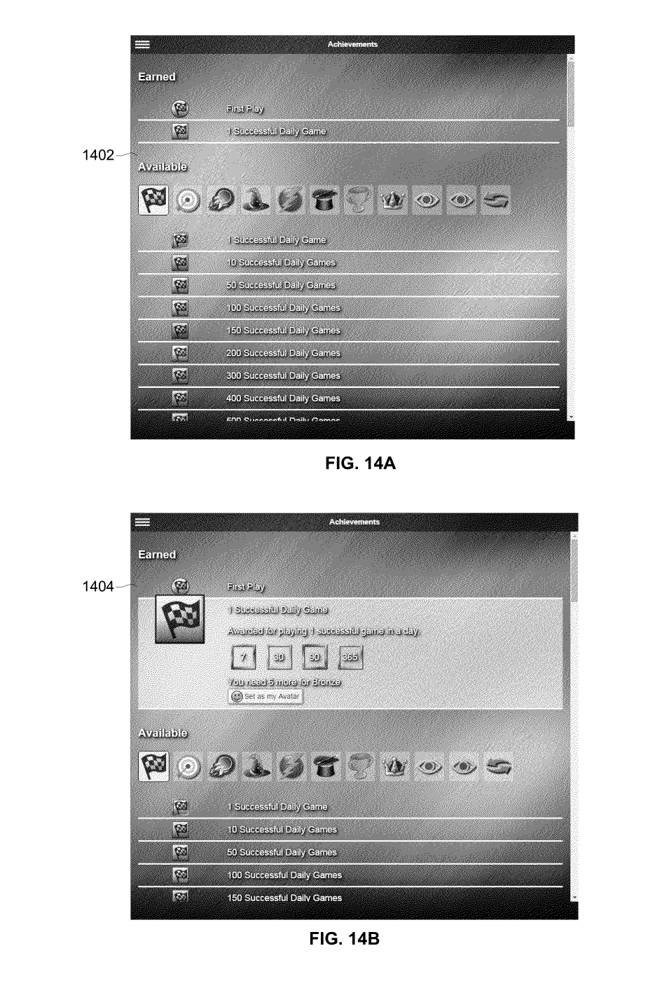

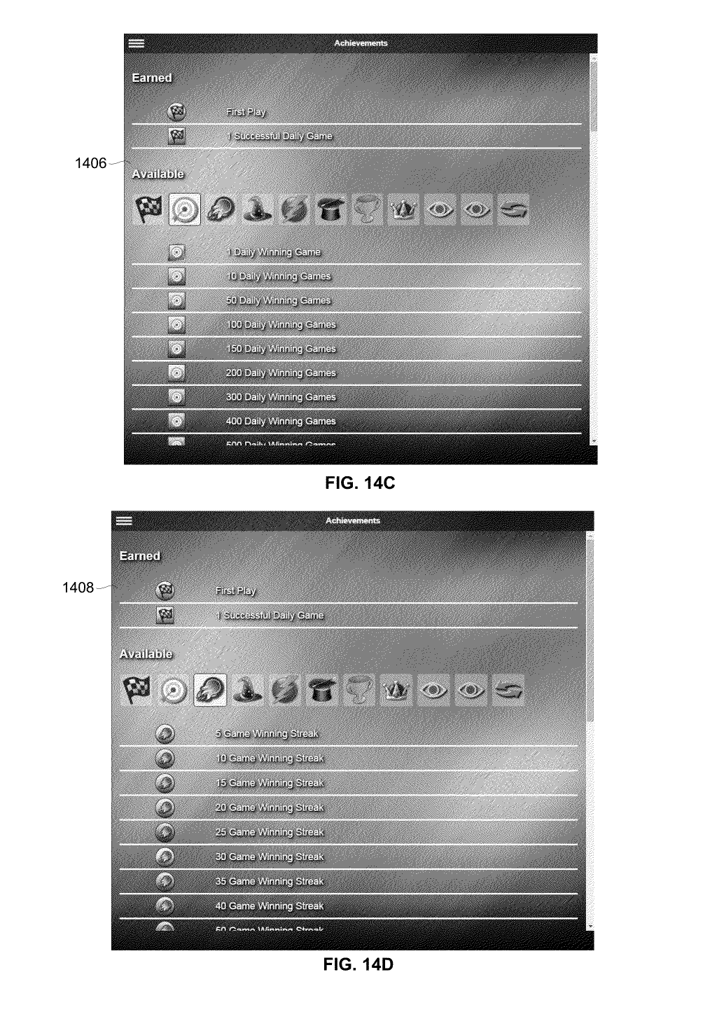

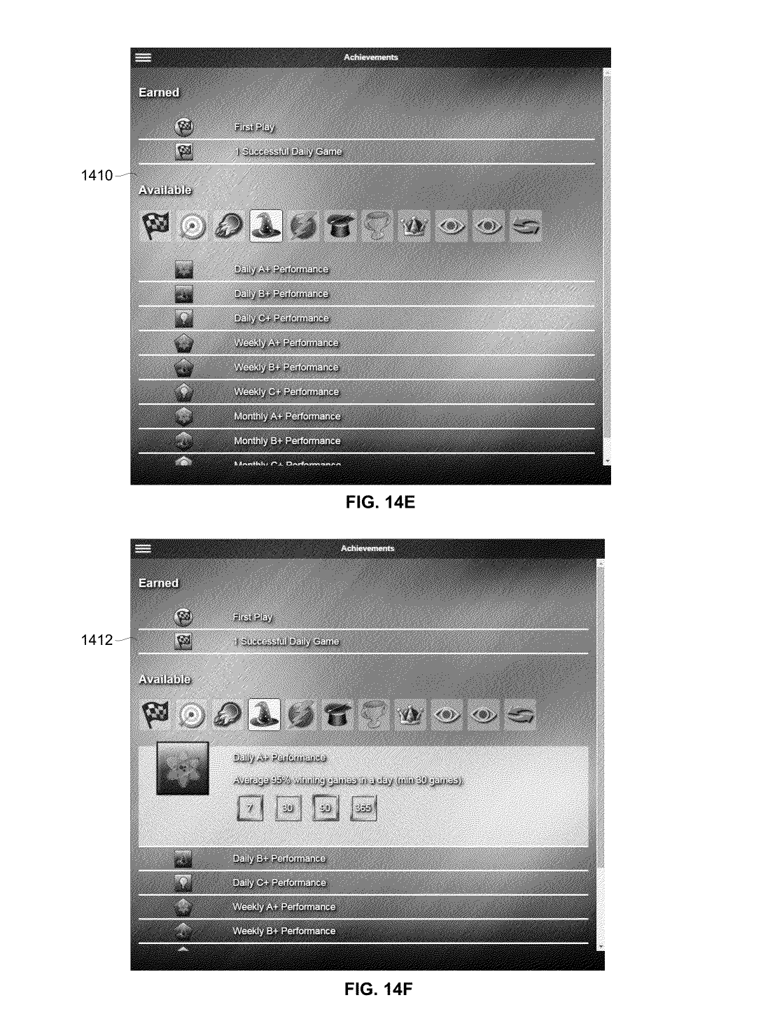

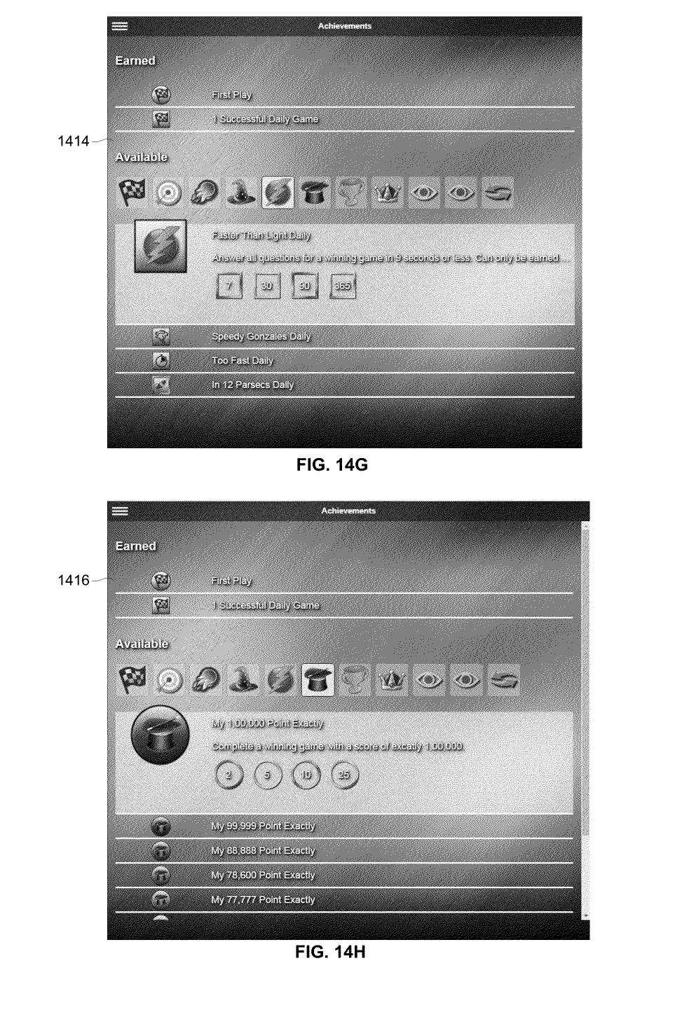

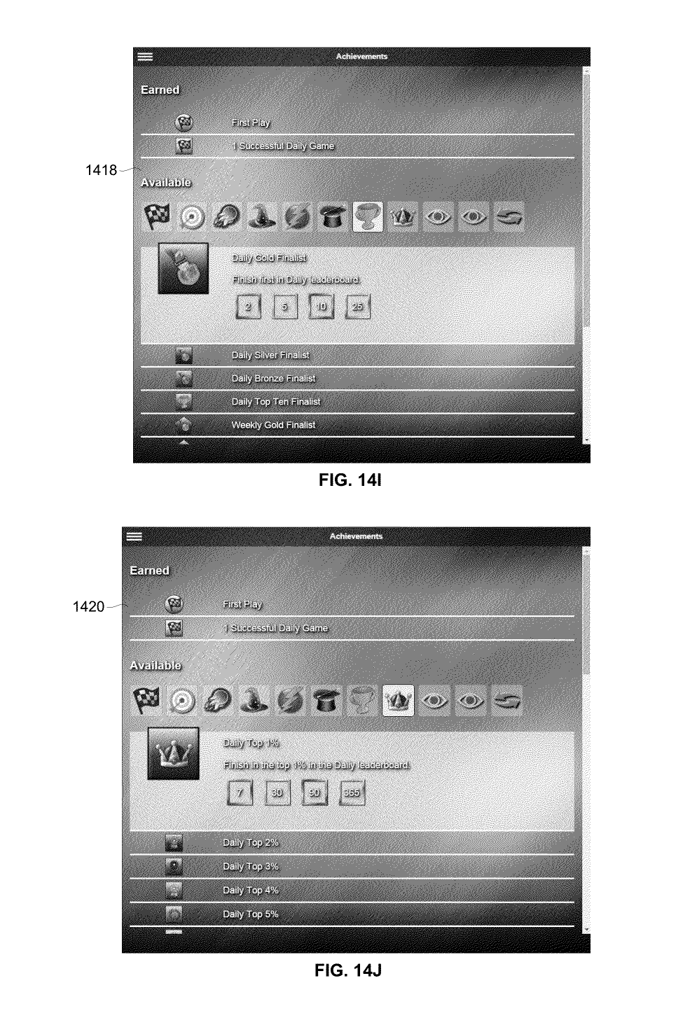

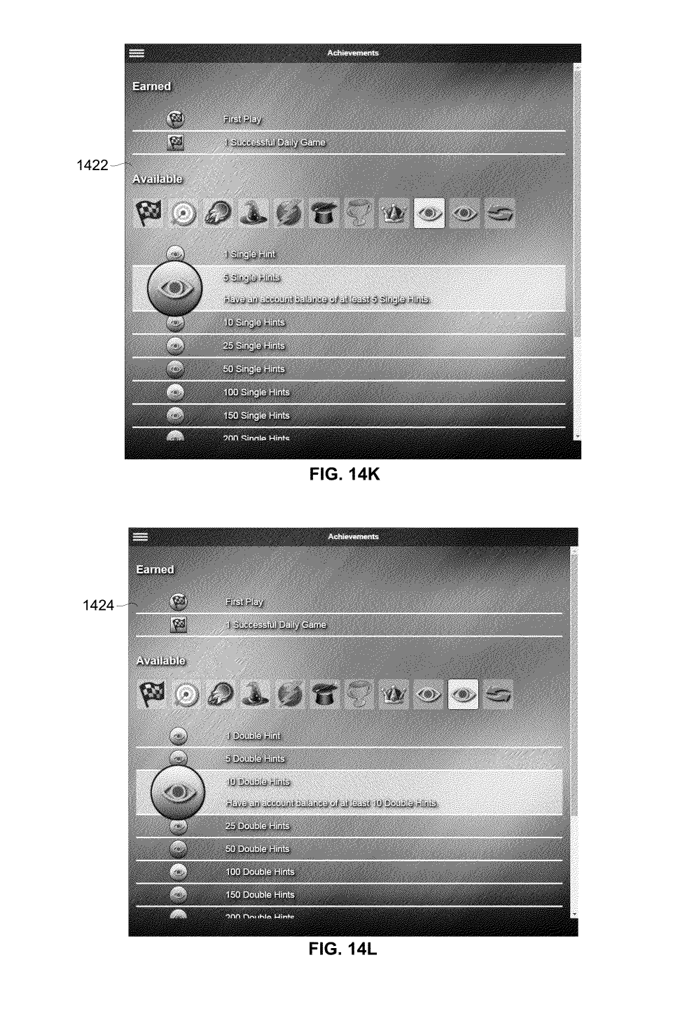

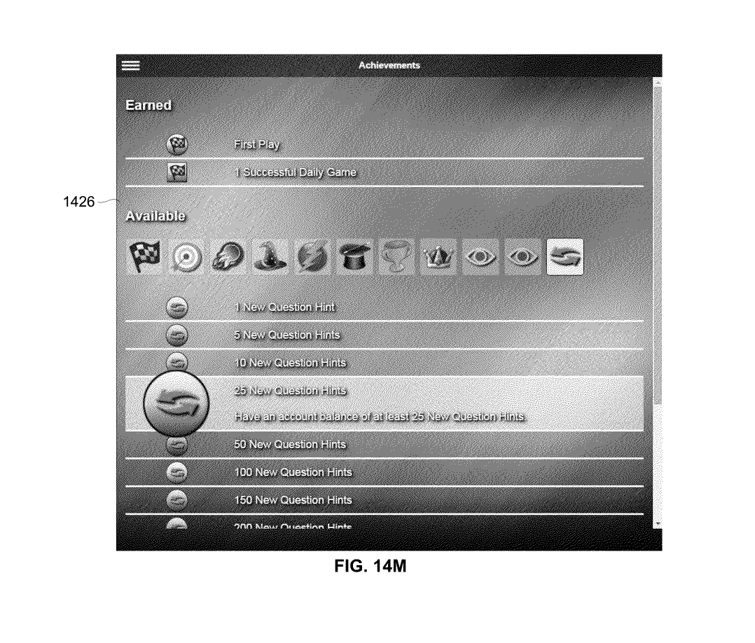

As shown in FIG. 12, after answering a single question or a series of questions (e.g., three) pertaining to an advertisement, software may be executed on the allocation server 100 to present a simulated spin of a wheel or slot machine, possibly with interaction from the user (e.g., pulling a simulated “handle”), for a chance to win a prize. As discussed above, each correctly answered question may give the user another chance to spin the wheel and win. The allocation server 100 determines the proper award using a cryptographically secure pseudorandom number generator or other random number generating device, and transmits award and prize data 136 back to the player device 130. The software then selects and displays an animation associated with the prize won by the user. Software executing on the allocation server 100 then determines whether to award the player new badges, as described herein. Upon completion of the set of questions 132 and a spin to determine awards, the entire process is reiterated and a new advertisement is selected by the allocation server 100 for transmittal to the player device 130, along with the questions 132 associated therewith. The player may then view the advertisement 132, provide answers 134 to the questions 132, and receive awards 136. As shown in FIGS. 13A-14M, the system can display a series of screens summarizing the player's achievements, progress, and awards.

Whether a player wins a prize is randomly determined by the allocation server 100 using a cryptographically secure pseudorandom number generator or other random number generating device, with certain parameters adjusting the probability of winning the prize. Certain prizes may be assigned lower or higher probabilities of being awarded than other prizes by software running on the allocation server 100, perhaps due to their desirability or rarity. For example, a cash prize of one dollar would have a higher probability of being awarded than a cash prize of five dollars. Factors such as whether the player has won a prize previously or recently, how long the player has been playing in the current session or across all sessions may be used to increase or decrease the probability of a prize being awarded by the software running on allocation server 100.

Unlike traditional games of chance or skill, the odds to win the present game may be manipulated by software (e.g., the Q/A module) running on the allocation server 100 in accordance with the teachings herein, e.g., to increase odds of winning. Odds may be manipulated by the allocation server 100 following a user's answering of a question, following a user's completion of a question set, at predetermined or random intervals of playtime, either based on the current session or the user's overall time playing the game, or at predetermined or random intervals based on the amount of time elapsed since the player has last won a prize.

In one embodiment, odds of winning a prize are increased by the allocation server 100 if the player correctly answers a question, either directly after the player's correct answer, or following the completion of the current question set. Odds of winning a prize are decreased if the player incorrectly answers a question, either directly after the player's answer, or following the completion of the current question set. In some embodiments, odds of winning a prize are increased as the amount of time a player has spent in-game increases. In some embodiments, odds of winning a prize are increased based on the amount of time a player has been playing the game without winning a prize. In some embodiments, after winning of a prize, the odds of winning a prize are set to a pre-determined or calculated default level. In some embodiments, there is a minimum cash award for specified time intervals such that everyone wins a minimum prize even if they are unable to answer the questions correctly.

In an embodiment of the invention, the notices regarding winning a prize or not may be animations displayed by software running on player device 130. In an embodiment of the invention, the animations may be interactive, like a video game. In another embodiment of the invention, the interactive animations may take the form of depictions of well-known games of skill or chance, including, but not limited to, spinners, slot machines, dice rolls, playing card games, such as poker, blackjack, baccarat, craps, etc., roulette, pachinko, keno, lotteries, and other casino, table, card, and random number games. In an embodiment of the invention, players may choose which interactive animation they would like to view or interact with. In an embodiment of the invention in which animations, interactive or not, are shown to the user upon winning a prize, the animations may be a single animation shown at the completion of an entire question set.

As shown in FIGS. 1-3, in the event of a cash prize, allocation server 100 sends awards data 138 to payment server 140 in order to credit the player's account (step 209). In an embodiment of the invention, following the correct answering of a question, a notice is presented to the player showing the player if they won a prize. A notice may also be shown if the player did not win a prize. Prizes 136 may be presented after each answer 134 is received or after all questions 132 regarding a particular advertisement 132 are answered. The system tracks winnings in the user's account page (see FIGS. 10A-10B) and provides tools for applying for a debit card, transferring winnings (e.g., to another player), and withdrawing winnings.

Allocation server 100 may award jackpots in lieu of regular prizes randomly, during specific time intervals, or at special occasions. Time intervals could be hourly, daily, weekly, monthly, yearly, or any other measurable time interval or combination thereof. Jackpots may also be associated with specific advertisements. In an embodiment of the invention, for a given amount of time, questions answered, or another metric regarding playing the game, a minimum quantity of prizes or prizes of a minimum value are awarded. In an embodiment of the invention, should the player answer all questions 132 in a set based on an advertisement 132 correctly, they will receive an entry into a weekly jackpot.

Bonus questions may also be provided by allocation server 100 to the player for an additional prize. A bonus question could take the form of asking the user to rate an advertisement on a scale of one to five, on a scale of one to one hundred, or on a binary scale, such as with a thumbs-up or thumbs-down. Players may also be asked whether they would be interested in purchasing the product or service shown in the advertisement, whether they have ever purchased the product or service shown before, or any other questions geared toward determining the marketing effect of the advertisement. Transmittal of bonus questions from the allocation server 100 to the player device 130, and transmittal of answers back to the allocation server 100 from the player device 130 may follow the same process as that of regular questions 132 and answers 134. Such questions concerning the rating of or interest in advertisements are not limited to bonus questions and could be included in the regular group of questions. Based on the user's responses, the system may tailor future advertisements and/or questions for particular user in accordance with his/her preferences. Thus, the content may become more relevant over time and more likely to interest the user and/or lead to a purchase.

Players may also be awarded points by the allocation server 100 based on their performance in answering the questions. Points may be awarded for correct answers, and may be based on the amount of time taken to answer them correctly. Players continue to accrue points as long as correct answers are given; once a player incorrectly answers a question, the number of points will be saved for ranking on the leaderboard and continuing on, points may be reset to zero. Points may be used to rank players on leaderboards; the more points a player has, the higher their position on the leaderboard.

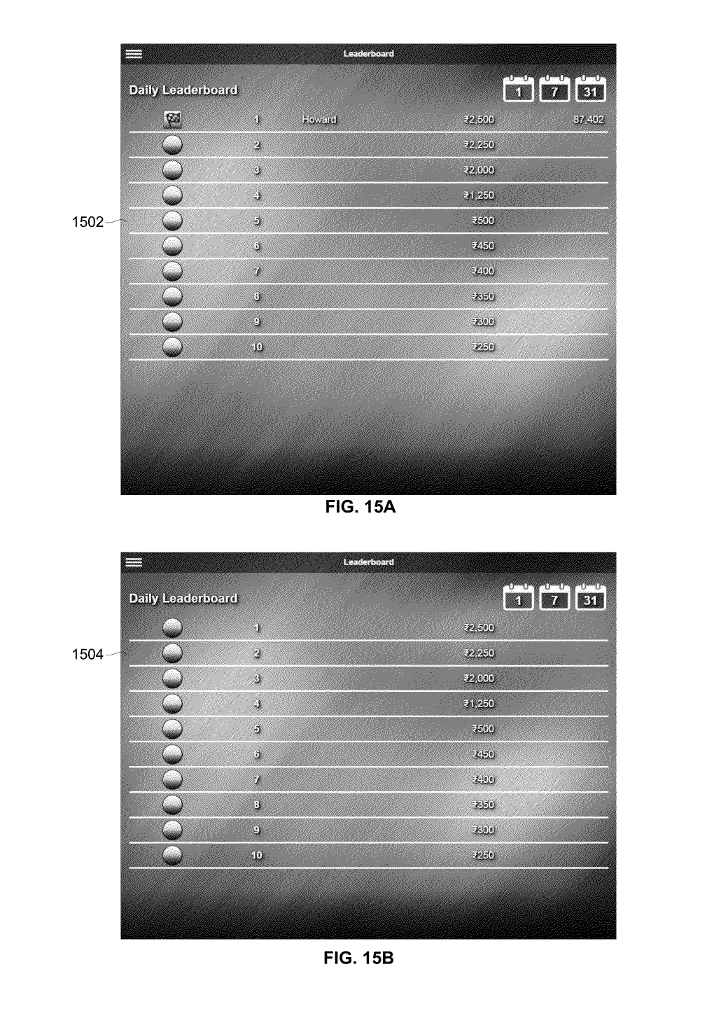

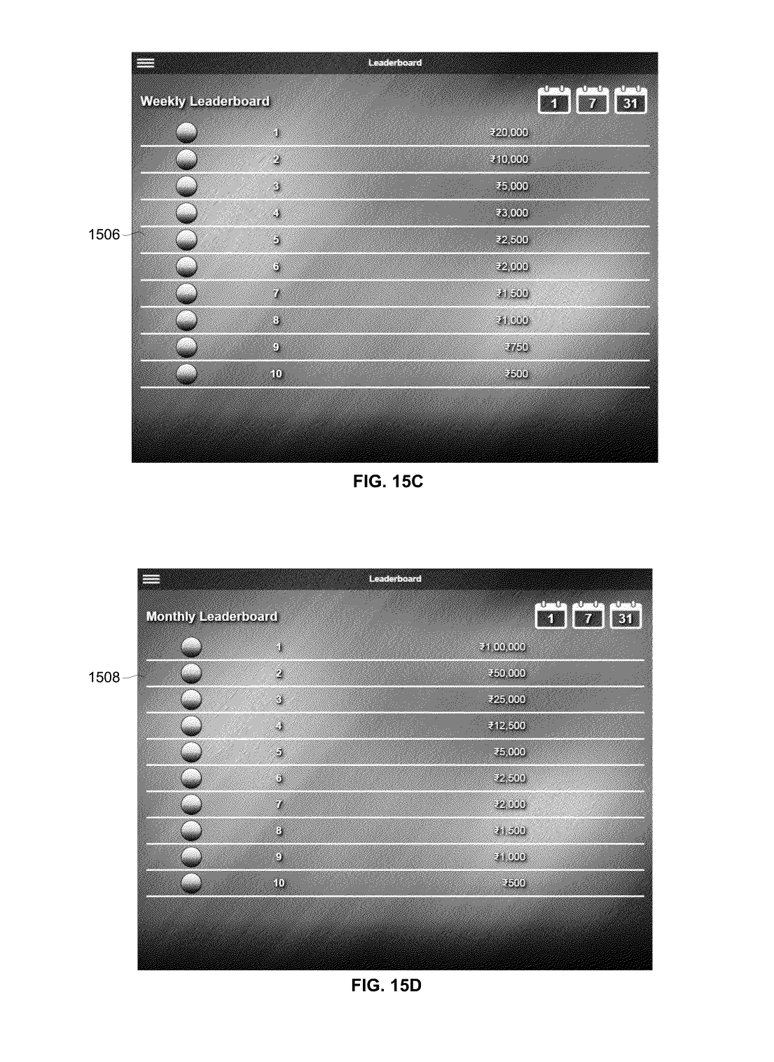

FIGS. 15A-15D shows and embodiment in which a leaderboard is implement with daily, weekly, and monthly prizes based on a player's accrued points. Positioning on the leaderboard may allow the player to win more prizes. In an embodiment of the invention, there are daily, weekly, and monthly leaderboards, and the players who appear on the leaderboards win additional prizes. Players may appear on the leaderboard for each point value entry the player has. Players need not answer a question correctly to appear on the leaderboard; point values will simply keep accruing and that entry will rise as the player answers more questions.

As shown in FIGS. 13B and 14A-14M, players may also receive badges based on their level of play. Badges may be generated on the fly for each player by the allocation server 100 and sent to user devices 130, and continually updated as the player progresses through the game. In particular, software executing on the allocation server 100 creates custom badges which may be the combination of various component parts, including various colors and shapes or symbols, each having different meanings. Components may be put together by the allocation server 100 and displayed in a user's profile page. Colors may differ in hue, value, saturation, brightness, gloss, shade, tint, or any other known property of color. Symbols may be letters, numbers, or any other known symbol or indicator. For instance, the background of a badge may indicate the time period for which it applies, be it daily, weekly, monthly, yearly, or any other time period. Additionally, the number of times a particular badge has been won may be indicated by the color of the badge's border.

For example, a badge may be awarded for winning a game on a single day. As the badge is awarded on consecutive days, the color of the badge's border may change to reflect the multiple wins of the particular badge. When the player then wins at least one game on consecutive days for a week, month, year, or any other time period, they may be awarded a badge for that time period as well, the new time period badge being distinct from the daily badge by a different badge background. One embodiment shown in FIGS. 14A-14M show various badges of difference colors and time durations associated with various achievements and awards in the game.

Players may also win referral prizes by referring other players to the game. Software running on allocation server 100 may generate a personal code to uniquely identify a user and provide referral prizes when another player signs up and plays using the referrer's personal code. The personal code may be an alphanumeric sequence, a password, a personal QR code, a URL, or other uniquely identifying piece of information that can be shared by the user (see FIG. 9). The allocation server 100 may also interface with a variety of other services via the Internet or other network, such as a mobile phone's contact list, a computer email directory, or social networks such as Facebook, Linked-In, Twitter, Pinterest, and Google+ in order for players to send referrals to others.

Referral prizes may be a percentage of the new player's winnings, either for a period of time, a number of questions, or indefinitely. Referral prizes may also take the form of increased regular prizes, either for a period of time, a number of questions, or indefinitely. Referral prizes may also be a one-time payout, or may take the form of a combination of the types of referral prizes proposed herein. In an embodiment, players who refer another receive ten percent of the referred player's prizes from the system, with no deduction to the amount paid out to the referred player. Referral prizes need not be capped.

As discussed above, prizes 136 may take the form of money, coupons, exclusive offers, and other rewards. Prizes may also be in-game bonuses, such as “lifelines” providing the ability to eliminate answer choices from consideration on a multiple choice question or receive a new question. Monetary prizes 138 may be disseminated directly to the winner in a variety of ways. In some embodiments, winnings are dispersed using cash cards such as debit cards, gift cards, game-specific cards and the like. Cash, check, direct deposit to a bank account, and other known methods may also be used. In an embodiment of the invention, prizes (e.g., money) may be transferrable to other players. In an embodiment of the invention, a player's preferred method of receiving monetary prizes 138 and the information associated therewith is linked to their player account. In an embodiment of the invention, a player's other prize information, such as that associated with coupons, exclusive offers, and other rewards, is linked with the player's account.

In some embodiments of the invention, a game-specific debit card 142 is used to disseminate winnings via payment server 140. The debit card 142 may be offered once the user reaches a minimum threshold of money in their prize account. Such a debit card 142 may be received from those running the game, either in person or via postal delivery, or a participating bank or other financial institution. For example, the allocation server 100 may be in communication with a payment server 140 via the Internet which receives notifications of an award 138 and issues a payment/debit card 142 to the corresponding user, or updates an existing payment account of the user. In one of embodiment of the invention utilizing the specialized kiosk, players may receive the debit card 142 from kiosks (e.g., located in public locations in the vicinities of the users).

The system may encourage users to use keep winnings on the debit card 142 to allow purchase information to be evaluated. For example, the system may allow for transfer of winnings to the debit card 142 and use of the debit card 142 without a fee. Transfers of winnings to a bank account or third party may require a fee. Purchases and other data, such as the use of coupons, exclusive offers, or other rewards, are recorded and tracked by payment server 140 and sent to allocation server 100 (step 211). In some embodiments, a player's game-specific debit card 142 is used to help track such information. In some embodiments, a player's game account is used to help track such information.

Such information can then be used to evaluate the effectiveness of the advertisements 112/122 and can also be used to provide more individualized and targeted advertising experiences to players. In a preferred embodiment, additional prizes such as cash rebates, coupons, and other incentives are awarded for purchasing products featured in advertisements previously viewed by the player. Other incentives may include in-game incentives such as better odds, higher payouts, participation in special winning pools and leader board positioning. This information may also be shared with the advertisers (without revealing personal information) to inform advertisers of the rate of purchases following users watching their ads or receiving their coupons.

In an embodiment of the invention, all purchase and player data 146 relating to the questions is tracked by allocation server 100, including the number of correct answers per advertisement, the number of correct answers overall, the amount of time spent per question for both correct and incorrect answers, etc. This data 146 can then be correlated with the information regarding the player's later purchases and use of coupons and exclusive offers to show the effectiveness of the advertisement overall. Taking it a step further, the data 146 can also be separated amongst demographics, including, but not limited to, those listed above, and compared to determine the effectiveness of the advertisements amongst demographics. This information 146 may then be provided to the media distributor 110 and/or advertiser 120 associated with the particular advertisement (step 213). In these ways the allocation server 100 transforms raw data 134 into useful advertising and marketing data 146, not only with respect to individual players, but in the aggregate as well.

The specialized kiosk of the present invention may include a variety of features not available in desktop or mobile versions of the game. In one embodiment of the invention, the kiosk vends the game-specific debit cards 142. In an embodiment of the invention, the kiosk can read game-specific debit cards 142, and other game-specific cards, to automatically identify a particular player, perhaps in conjunction with other information such as a password or personal identification number.

The kiosk would also work to ensure an optimal advertising experience, as advertisers could design their ads based on the specialized and known hardware in the kiosk. Mobile and desktop environments tend to have to account for a variety of hardware. With the kiosk, parameters such as screen resolution, the number of speakers and their locations, etc. are known can be optimized for, providing a better audiovisual experience.

Although the invention has been described with reference to a particular arrangement of parts, features and the like, these are not intended to exhaust all possible arrangements or features, and indeed many modifications and variations will be ascertainable to those of skill in the art.

What is claimed is:

1. An advertising-based gamification system for delivering advertisements and measuring delivery and effectiveness of the advertisements, comprising:
an allocation server, in communication with a plurality of devices remote to said allocation server, programmed to present media advertisements for display on the plurality of devices and receive user input in response to questions posed about the media advertisements from the plurality of devices;
a database including a plurality of stored data objects including media advertisements and questions, each of the questions associated in said database with a particular media advertisement, the media advertisements and the questions stored in a plurality of languages;
a location module executing on said allocation server receiving location data indicative of a location of at least one of the plurality of devices;
software executing on said allocation server to selectively present one of the media advertisements and a plurality of associated questions from the stored data objects for transmission to and display on a device based on at least one of the location data and a language preference;
software executing on said allocation server to receive and store data indicative of answers to the questions from the device; and
software executing on said allocation server to quantify views and effectiveness of the media advertisements.

2. The system according to claim 1, further comprising:
a translation module executing on said allocation server, said translation module monitoring translation statuses of each of the stored data objects in the plurality of languages in said database.

3. The system according to claim 2, said translation module issuing commands to deactivate data objects including media advertisements and questions having incomplete or out of date translations.

4. The system according to claim 2, wherein said translation module transmits alerts to one or more administrators of said allocation server in response to a detection of an incomplete or out of date translation of one of the media advertisements or the questions.

5. The system according to claim 1, wherein at least a portion of the plurality of devices are mobile devices including GPS devices sending the location data to said allocation server, wherein at least a portion of the media advertisements and associated questions presented for display on the device are associated with products or services offered in a current location of the device based on the location data.

6. The system according to claim 1, wherein the location data includes network data indicative of a wireless network in use by a device, wherein at least a portion of the media advertisements and associated questions presented for display on the device are associated with products or services offered in a current location of the device based on the network data.

7. The system according to claim 1, wherein the location data includes data input by a user of the device.

8. The system according to claim 1, further comprising:
software executing on said allocation server for generating prize data for the user based at least in part on a number of correct answers.

9. The system according to claim 1, further comprising:
software executing on said allocation server for generating prize data for the user based at least in part on a pseudorandom number generator and an odds adjustment generated by said software based on at least one of a length of time since the user began interacting with the system or a length of time since the user has won a prize in the system.

10. The system according to claim 1, further comprising:
a payment server in communication with said allocation server;
a payment card including indicia of the award amount for use at a retailer;
software executing on said payment server to receive purchase data from the retailer indicative of a purchase made by a user with said payment card and transmit the purchase data to said allocation server.

11. The system according to claim 1, wherein the plurality of devices include mobile phone devices in communication with said allocation server at least in part via a cellular data network.

12. The system according to claim 1, wherein the media advertisements are videos.

13. An advertising-based gamification system for delivering advertisements and measuring delivery and effectiveness of the advertisements, comprising:
an allocation server, in communication with a plurality of mobile devices remote to said allocation server, programmed to present media advertisements for display on the plurality of devices and receive user input in response to questions posed about the media advertisements from the plurality of devices;
a database including a plurality of stored data objects including media advertisements and questions, each of the questions associated in said database with a particular media advertisement, the media advertisements and the questions stored in a plurality of languages;
a location module executing on said allocation server receiving location data indicative of a location of at least one of the plurality of devices, the location data including at least one of GPS data or network connectivity data from the at least one of the plurality of devices;
software executing on said allocation server to selectively present one of the media advertisements and a plurality of associated questions from the stored data objects for transmission to and display on a device based on the location data and a language preference, the one of the media advertisements representing products or services offered in a current location of the device;
software executing on said allocation server to receive and store data indicative of answers to the questions from the device.

14. The system according to claim 13, further comprising:
a translation module executing on said allocation server, said translation module monitoring translation statuses of each of the stored data objects in the plurality of languages in said database.

15. The system according to claim 14, said translation module issuing commands to deactivate data objects including media advertisements and questions having incomplete or out of date translations.

16. The system according to claim 14, wherein said translation module transmits alerts to one or more administrators of said allocation server in response to a detection of an incomplete or out of date translation of one of the media advertisements or the questions.

17. A method of providing an advertising-based gamification system for delivering advertisements and measuring delivery and effectiveness of the advertisements, comprising steps of:
storing, via software executing on an allocation server, a plurality of data objects in a database, the data objects including media advertisements and questions stored in a plurality of languages;
monitoring, via software executing on the allocation server, the data objects to determine if each data object is stored in each of the plurality of languages;
activating, via software executing on the allocation server, data objects in which a media advertisement and a predetermined number of questions associated with the media advertisement are available in each of the plurality of languages;
selectively presenting, via software executing on the allocation server, the media advertisement and two or more of the questions associated with the media advertisement for display on a device based on at least one of a location and a language of a user of the device;
receiving, via software executing on an allocation server, data indicative of answers to the two or more of the questions from the device.

18. The method according to claim 17, further comprising the step of:
presenting an interface to the user via the device to determine prize data, wherein software executing on said allocation server generates the prize data for the user based at least in part on a pseudorandom number generator and an odds adjustment generated by said software based on at least one of a length of time since the user began interacting with the system or a length of time since the user has won a prize in the system.

19. The method according to claim 17, further comprising the step of determining a location of the device by receiving location data from the device, the location data including at least one of GPS data or network connectivity data indicative of a network over which the device is currently communicating.

20. The method according to claim 17, further including the steps of:
generating a payment card associated with the user, the payment card including indicia of a monetary award amount for use at a retailer; and
receiving purchase data from the retailer indicative of a purchase made by the user with the payment card and transmitting the purchase data to the allocation server.
